(19) United States
(12) Patent Application Publication
(10) Pub. No.: US 2014/0320365 A1
(43) Pub. Date: Oct. 30, 2014

(54) MAGNETIC ANTENNA STRUCTURES

(71) Applicants: Yang-Ki Hong, Tuscaloosa, AL (US); Jaejin Lee, Tuscaloosa, AL (US)

(72) Inventors: Yang-Ki Hong, Tuscaloosa, AL (US); Jaejin Lee, Tuscaloosa, AL (US)

(21) Appl. No.: 14/263,251

(22) Filed: Apr. 28, 2014

Related U.S. Application Data
(60) Provisional application No. 61/816,766, filed on Apr. 28, 2013.

(51) Int. Cl. H01Q 1/38

(52) U.S. Cl. CPC H01Q 1/38
USPC 343/787

(57) ABSTRACT

A magnetic antenna structure has a substrate (e.g., a flexible printed circuit board (PCB) carrier), a magneto-dielectric (MD) layer, and an antenna radiator. The MD layer increases electromagnetic (EM) energy radiation by lowering the EM energy concentrated on the antenna substrate. The resonant frequency and antenna gain of the magnetic antenna structure are generally lower and higher, respectively, relative to dielectric antennas of comparable size. Thus, the magnetic antenna structure provides better miniaturization and high performance with good conformability.

### CROSS REFERENCE TO RELATED APPLICATION

This application claims priority to U.S. Provisional Patent Application No. 61/816,766, entitled “Flexible Magnetic Antenna Structures” and filed on Apr. 28, 2013, which is incorporated herein by reference.

### RELATED ART

Wireless communication products and services are growing at a rapid pace due in part to increase demands for mobile or handheld electronic devices. In order to enhance mobility and decrease power requirements, techniques are constantly evolving to reduce the overall size or footprint of wireless communication devices, and further size reductions are generally desired. Antenna structures often occupy a significant amount of real estate within a wireless communication product, such as a radio or cellular telephone, and a relatively large number of antenna structures may be embedded in some wireless communication products. To help reduce the footprint of wireless communication products, it is generally desirable to decrease the size of the antenna structure or structures without significantly decreasing antenna bandwidth or gain.

### BRIEF DESCRIPTION OF THE DRAWINGS

The disclosure can be better understood with reference to the following drawings. The elements of the drawings are not necessarily to scale relative to each other, emphasis instead being placed upon clearly illustrating the principles of the disclosure. Furthermore, like reference numerals designate corresponding parts throughout the several views.

FIG. 1 is a block diagram illustrating an exemplary embodiment of a wireless communication system.

FIG. 2 is an exploded view depicting an exemplary embodiment of a flexible magnetic antenna structure.

FIG. 3 is an exploded view depicting another exemplary embodiment of a flexible magnetic antenna structure.

FIG. 4 is an exploded view depicting yet another exemplary embodiment of a flexible magnetic antenna structure.

FIG. 5A depicts an exemplary embodiment of a flexible magnetic single-input single-output (SISO) antenna element.

FIG. 5B depicts the flexible magnetic SISO antenna element illustrated by FIG. 5A.

FIG. 5C is a top view depicting the flexible magnetic SISO antenna element illustrated by FIG. 5A.

FIG. 6A depicts an exemplary embodiment of a flexible magnetic multiple-input multiple-output (MIMO) antenna element.

FIG. 6B depicts the flexible magnetic MIMO antenna element illustrated by FIG. 6A.

FIG. 7A is a graph illustrating simulated resonance frequency and antenna gain for a range of magnetic film thickness in a substrate structure.

FIG. 7B is a graph illustrating simulated return loss for a range of magnetic film thickness in a substrate structure.

FIG. 8A is a graph illustrating simulated resonance frequency and antenna gain for a range of magnetic film thickness in an overleaf structure.

FIG. 8B is a graph illustrating simulated return loss for a range of magnetic film thickness in an overleaf structure.

FIG. 9A is a graph illustrating simulated resonance frequency and antenna gain for a range of magnetic film thickness in an embedded structure.

FIG. 9B is a graph illustrating simulated return loss for a range of magnetic film thickness in an embedded structure.

FIG. 10 is a graph illustrating simulated resonance frequency and antenna gain for a range of magnetic film thickness in a flexible magnetic MIMO antenna element.

FIG. 11A depicts an exemplary embodiment of a flexible magnetic antenna structure after formation of a flexible printed circuit board (PCB) carrier.

FIG. 11B depicts an exemplary embodiment of the flexible magnetic antenna structure of FIG. 11A after deposition of a magneto-dielectric (MD) layer on the PCB carrier.

FIG. 11C depicts an exemplary embodiment of the flexible magnetic antenna structure of FIG. 11B after fabrication of an antenna radiator on the MD layer.

FIG. 11D depicts an exemplary embodiment of the flexible magnetic antenna structure of FIG. 11C after deposition of a top MD layer over the antenna radiator depicted by FIG. 11C.

### DETAILED DESCRIPTION

The present disclosure generally relates to magnetic antenna structures, such as single-input, single output (SISO) or multiple-input, multiple-output (MIMO) antenna structures, for wireless communication. In one embodiment, a flexible magnetic antenna structure comprises a flexible printed circuit board (PCB) carrier, a magneto-dielectric (MD) layer, and an antenna radiator. The MD layer increases electromagnetic (EM) energy radiation by lowering the EM energy concentrated on the flexible PCB carrier. The resonant frequency and antenna gain of the flexible magnetic antenna structures described herein are generally lower and higher, respectively, relative to flexible dielectric antennas of comparable size. Thus, the flexible magnetic antenna structures provide better miniaturization and high performance with good conformability.

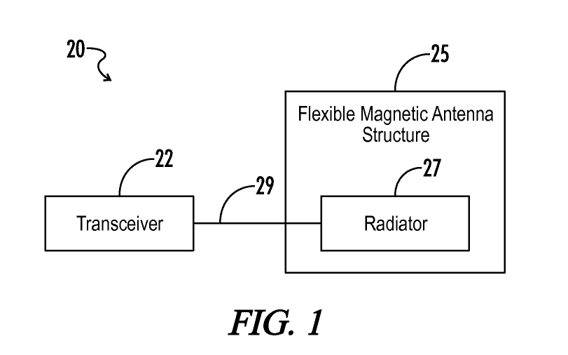

FIG. 1 depicts an exemplary embodiment of a wireless communication system 20 having a transceiver 22 that is coupled to a flexible magnetic antenna structure 25. In particular, the transceiver 22 is conductively coupled to a conductive radiator 27 via a conductive connection 29 (e.g., a wire or cable). When transmitting, the transceiver 22 transmits to the structure 25 an electrical signal that wirelessly radiates from the radiator 27 for reception by a remote transceiver (not shown). An electrical signal wirelessly transmitted from a remote transceiver (not shown) is received by the radiator 27 and passed to the transceiver 22 via the connection 29. Note that various types of transceivers 22 are possible, such as Frequency Modulation (FM) radios, network transceivers (e.g., 2G, 3G, or 4G), Global Positioning System (GPS) transceivers, Bluetooth transceivers, Wireless Local Area Network (WLAN) transceivers, dedicated short-range communication transceivers, and other types of known wireless transceivers.

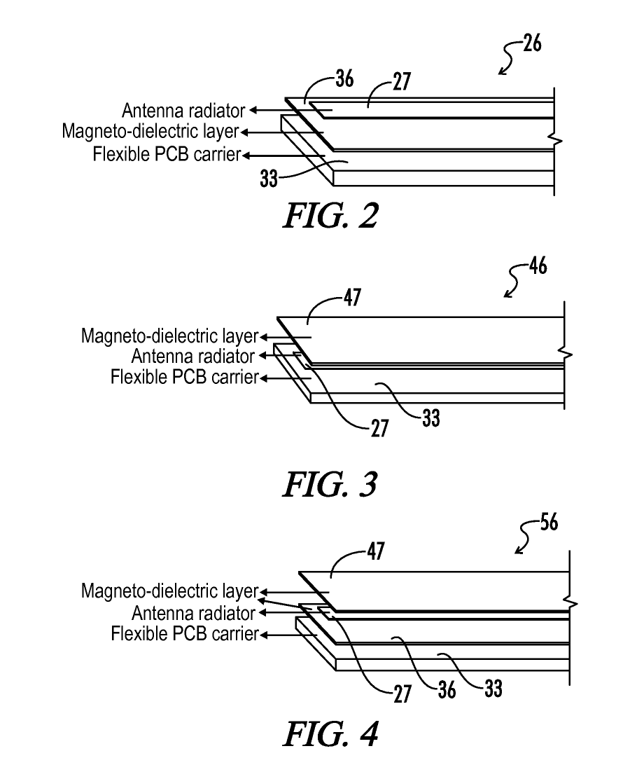

FIG. 2 depicts an exemplary embodiment of a flexible magnetic antenna structure 26. As shown by FIG. 2, the structure 26 has a flexible substrate 33. In one embodiment, the substrate 33 is a flexible printed circuit board (PCB) and shall be referred to as the “flexible PCB carrier,” but other types of flexible or non-flexible substrates 33 are possible in other embodiments. The flexible PCB carrier 33 is composed of a dielectric material, such as Kapton polymide, polyvinyle chloride (PVC), polyurethane form, or polyethylene terephthalate (PET). A magnetic layer 36 is formed on the flexible PCB carrier 33, and the radiator 27 is formed on the magnetic layer 36. The magnetic layer 36 is magneto-dielectric and shall be referred to hereafter as a “magneto-dielectric (MD) layer.” The material of the MD layer 36 has a relative permeability (μᵣ) and a relative permittivity (εᵣ) both greater than 1. In one embodiment, the MD layer 36 is a spinel ferrite (e.g., Ni—Zn, Mn—Zn, Ni—Zn—Cu, Ni—Mn—Co, Co, Li—Zn, and/or Li'Mn ferrites), hexagonal ferrite (e.g., M-, Y-, Z-, X-, and/or U-type), and/or other magnetic composite. A structure 26, such as is depicted by FIG. 2, in which an MD layer 36 is formed between the radiator 27 and the PCB carrier 33 with no MD layer on top of the radiator 27 shall be referred to herein as a “substrate structure.”

FIG. 3 depicts another exemplary embodiment of a flexible magnetic antenna structure 46. As can be seen by comparing FIGS. 2 and 3, the structure 46 of FIG. 3 is similar to the substrate structure 26 shown by FIG. 2 except that an MD layer 47 is formed on top of the radiator 27 instead of between the radiator 27 and the PCB carrier 33. That is, the radiator 27 is between the MD layer 47 and the PCB carrier 33. Like the MD layer 36 of FIG. 2, the MD layer 47 of FIG. 3 is composed of magnetic material having a relative permeability (μᵣ) and a relative permittivity (εᵣ) both greater than 1. A structure 46, such as is depicted by FIG. 3, in which an MD layer 47 is formed on top of the radiator 27 with no MD layer between the radiator 27 and the PCB carrier 33 shall be referred to herein as an “overleaf structure.”

FIG. 4 depicts another exemplary embodiment of a flexible magnetic antenna structure 56. As can be seen by comparing FIGS. 2-4, the structure 56 of FIG. 4 is similar to the substrate structure 26 shown by FIG. 2 and the overleaf structure 46 shown by FIG. 3 except that the structure 56 has both an MD layer 36 formed between the radiator 27 and the PCB carrier 33 and an MD layer 47 formed on top of the radiator 27. That is, the radiator 27 is embedded between the MD layers 36 and 47. A structure 56, such as is depicted by FIG. 4, in which the radiator 27 is embedded between MD layers 36 and 47 shall be referred to herein as an “embedded structure.”

In each of the embodiments shown in FIGS. 2-4, the presence of an MD layer enhances EM energy radiation by lowering the EM energy concentrated on the flexible PCB carrier 33, thereby permitting an increase in antenna gain and a reduction in the size of the antenna structures and, specifically, the radiator 27 for a given level of antenna performance. Indeed, the MD layer can lead to antenna miniaturization by a factor of the refractive index (n=(μᵣεᵣ)^{0.5}).

Generally, antenna size is proportional to the wavelength (λ) of the incident wave, which can be shortened by the refractive index (n) of the medium. An MD layer having both μᵣ and εᵣ can miniaturize an antenna, according to λ=λ₀/(μᵣεᵣ)^{0.5}, where λ₀ is the wavelength in free space. In addition, bandwidth and impedance matching characteristics can be improved with the μᵣ of the antenna substrate.

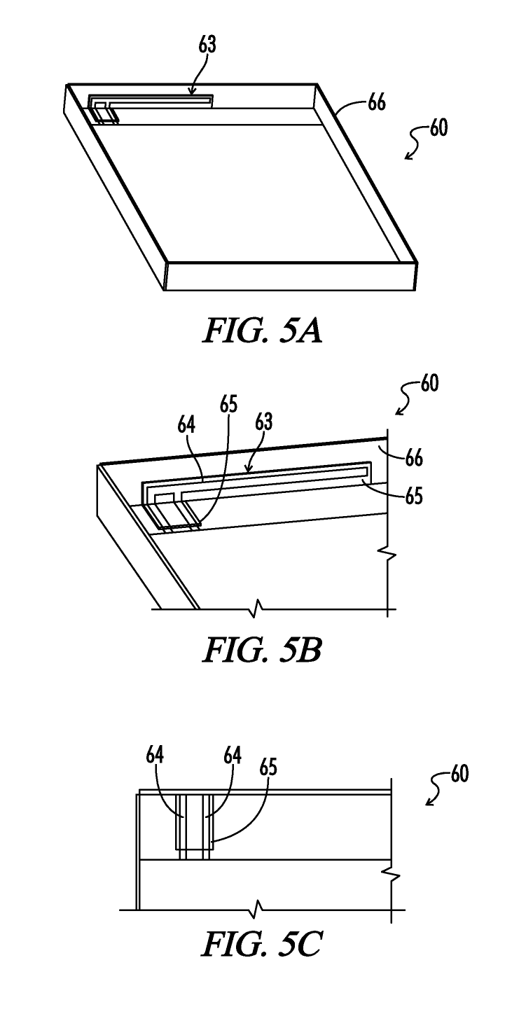

FIGS. 5A-5C depict an exemplary embodiment of a flexible magnetic SISO antenna element 60 having a substrate structure 63 similar to the structure 26 shown by FIG. 2. Specifically, the substrate structure 63 has a radiator 64 formed on an MD layer 65. Such substrate structure 63 is formed on an inner wall of a non-conductive (e.g., plastic) housing 66. Note that the housing 66 is shown with a top of the housing 66 removed for illustrative purposes in order to show components normally hidden from view. In actuality, the housing 66 may completely enclose the flexible magnetic SISO antenna element 60. Further, the transceiver 22 (not shown in FIGS. 5A-5C for simplicity of illustration) may reside within the housing 66 and be conductively coupled to the radiator 64.

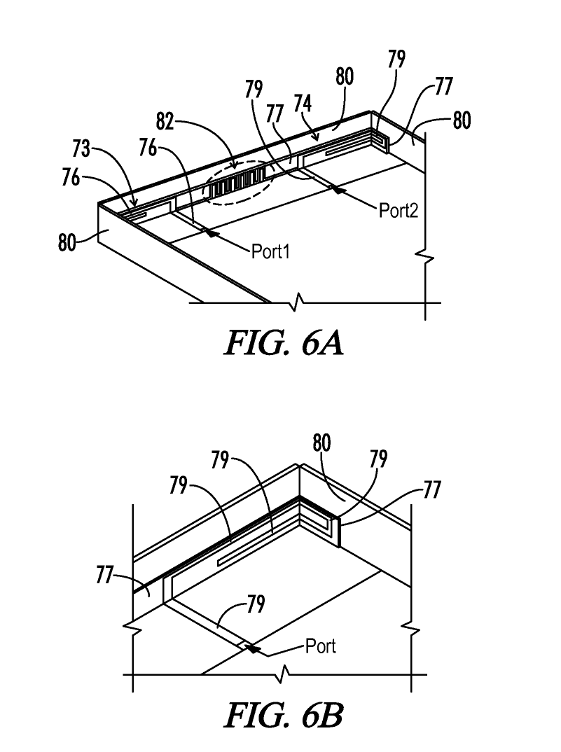

FIGS. 6A-6B depict an exemplary embodiment of a flexible magnetic MIMO antenna element 70 having substrate structures 73 and 74 similar to the structure 26 shown by FIG. 2. Specifically, the substrate structure 73 has a radiator 76 formed on an MD layer 77, and the substrate structure 74 has a radiator 79 formed on the MD layer 77. Such substrate structures 73 and 74 are formed on a non-conductive (e.g., plastic) housing 80. Note that, like the housing 66 shown by FIG. 5A, the housing 80 is shown in FIGS. 6A-6B with a top of the housing 80 removed for illustrative purposes in order to show components normally hidden from view. In actuality, the housing 80 may completely enclose the flexible magnetic MIMO antenna element 70. Further, the transceiver 22 (not shown in FIGS. 6A-6B for simplicity of illustration) may reside within the housing 80 and be conductively coupled to the radiators 76 and 79.

In addition, a decoupling network 82 is formed on the MD layer 77 between the substrate structures 73 and 74. The decoupling network 83 comprises conductive material that is coupled to each radiator 76 and 79 and forms a planar coil having a number of turns, as shown by FIG. 6A.

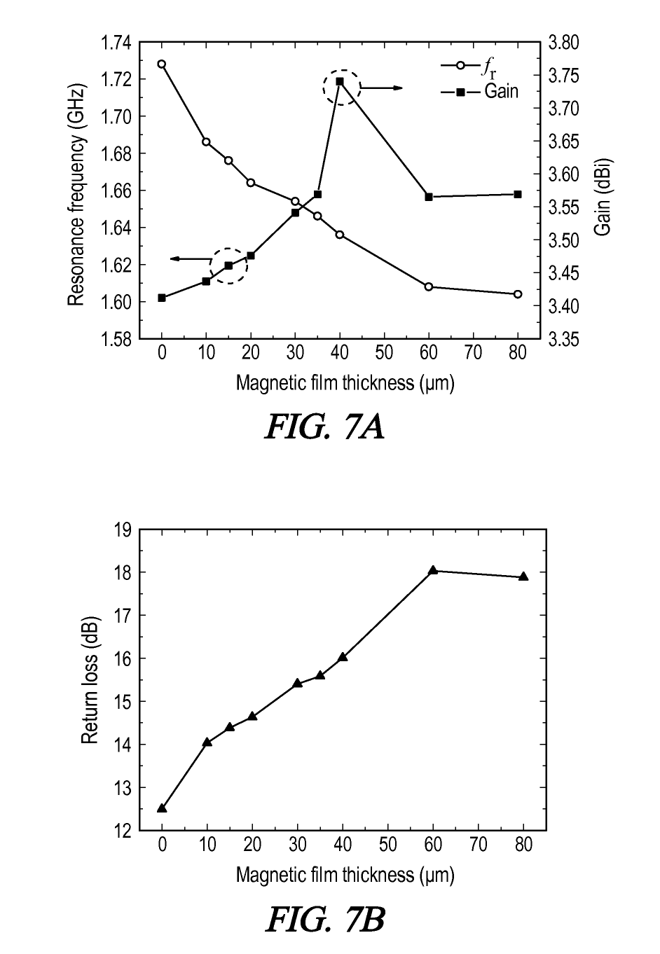

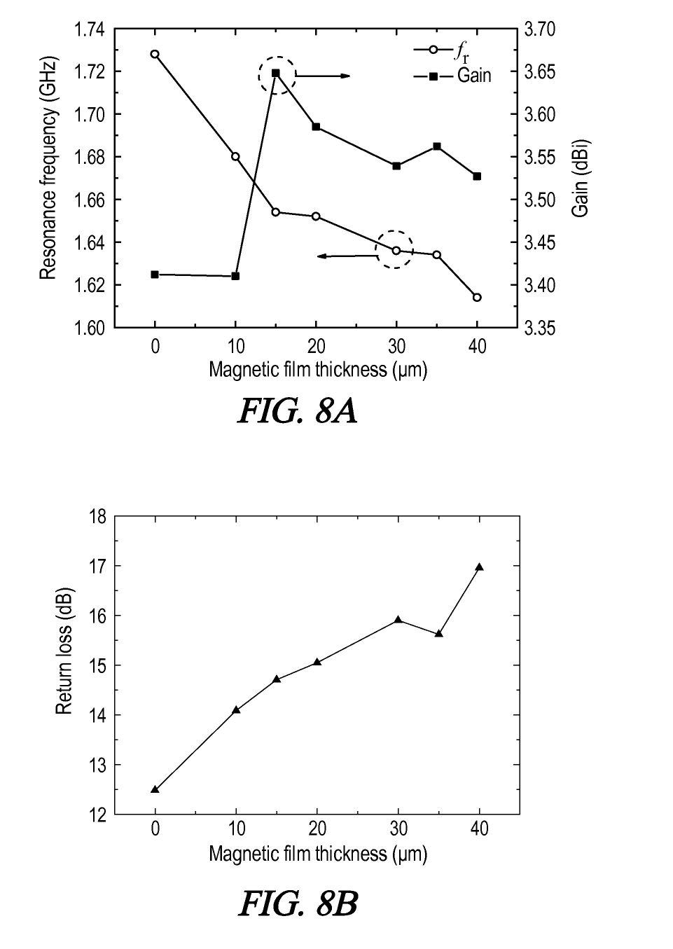

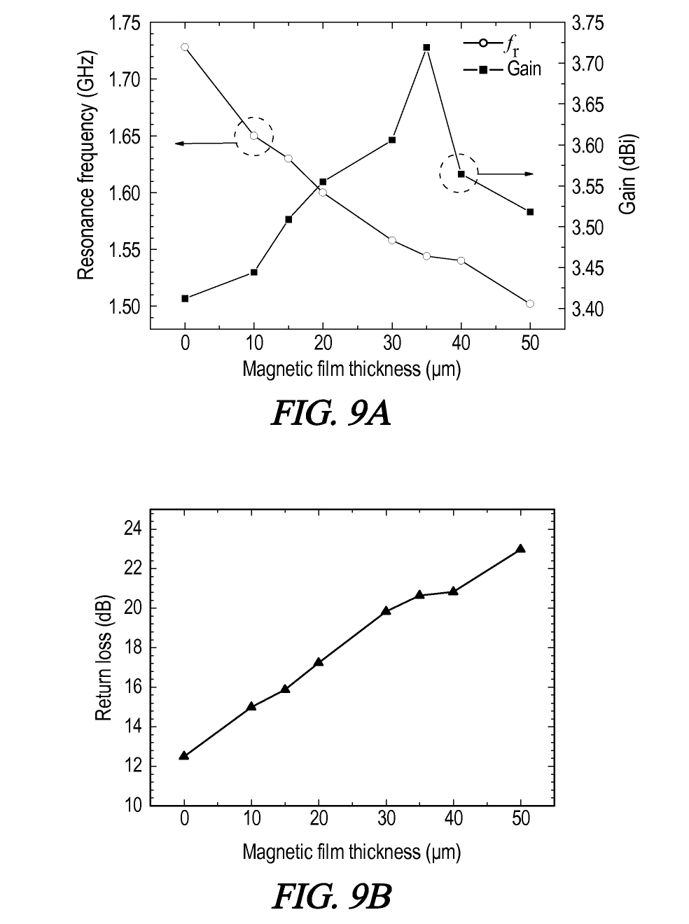

Simulated antenna performance for a substrate structure 26 is shown by FIGS. 7A-7B, and simulated antenna performance for an overleaf structure 46 is shown by FIGS. 8A-8B. Further, simulated antenna performance for an embedded structure 56 is shown by FIGS. 9A and 9B. It is noted that antenna gain shows a peaking effect as the magnetic film thickness (i.e., the thickness of the MD layer) is increased for all antenna types, while the resonant frequency decreases monotonously with the magnetic film thickness. This confirms that higher gain and larger miniaturization factor than a flexible dielectric antenna can be achieved using the MD layer. In addition, the return loss increases with the magnetic film thickness, thereby improving the antenna impedance matching. There exists an optimal thickness for achieving the highest antenna gain, which is dependent on the antenna structure. For example, the peak gain from the substrate structure in FIG. 7A was about 3.74 dBi at 40 μm thick MD layer, which is much higher than about 3.41 dBi for a dielectric substrate antenna structure. Accordingly, the gain of a flexible magnetic antenna structure is much higher than that of a flexible dielectric antenna structure.

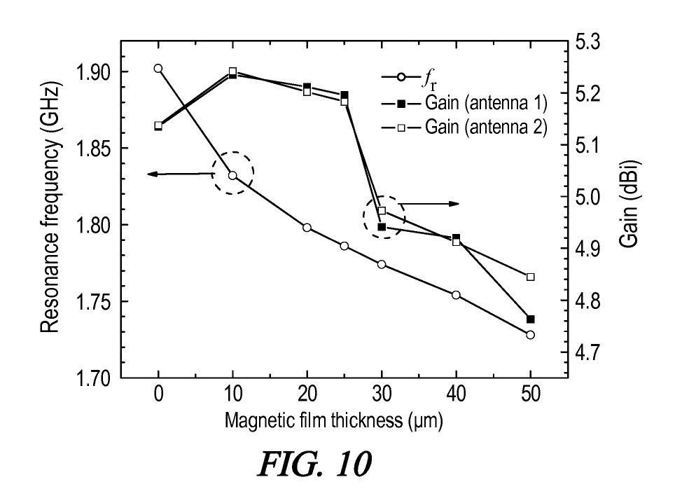

In order to increase data transfer rate, two types of flexible MIMO antenna elements were designed and tested. One such element (“antenna 1”) had a flexible magnetic antenna structure 26, as shown by FIG. 2, and the other element (“antenna 2”) had a flexible dielectric antenna structure. Results of the testing are shown in FIG. 10. As shown by FIG. 10, the antenna resonant frequency decreases with increasing magnetic film thickness, thereby implying that the antenna size can be reduced like an SISO antenna. Therefore, antenna miniaturization can be achieved, and further separation between two antenna structures is allowed, thereby decreasing the mutual coupling and increasing isolation. The design of a complex decoupling network can be simplified or eliminated through the presence of an MD layer.

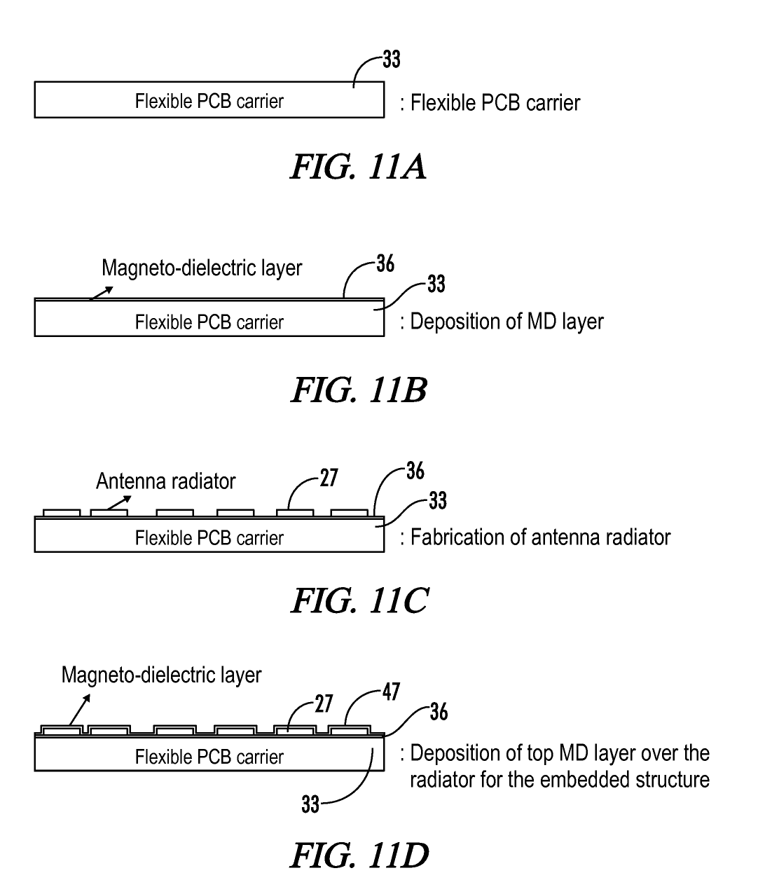

FIGS. 11A-11D depict an embedded structure at different stages during fabrication. First, an MD layer 36 less than approximately 50 micrometers (μm) is deposited on a flexible PCB carrier 33, as shown by FIGS. 11A-11B, followed by patterning of an antenna radiator 27, as shown by FIG. 11C. The radiator 27 is conductively coupled to connection 29 (FIG. 1), and an MD layer 47 less than approximately 50 μm is then deposited such that the radiator 27 is embedded between MD layers 36 and 47, as shown by FIG. 11D. Note that, in one embodiment, the flexible PCB carrier 33 generally withstands temperature up to about 400 degrees Celsius (C.). Thus, a low-temperature deposition process, such as screen printing, ferrite spin-spray, and aerosol deposition, can be used for MD layer deposition. The radiator 27 may be fabricated using electroplating, sputtering deposition, and other deposition techniques can be used with photolithography process or other mask fabrication processes. In other embodiments, other types of microfabrication techniques can be used, and other dimensions of the components of the antenna structure are possible. Further, similar manufacturing techniques may be used for the substrate structure and overleaf structure.

In various embodiments described above, substrate 33 is described as a flexible PCB carrier. However, it should be emphasized that other types of substrates are possible in other embodiments. Indeed, it is not necessary for the substrate 33 to be flexible. Further, while it is generally desirable for the substrate 33 to be composed of dielectric material, non-dielectric substrates may be used, if desired.

Now, therefore, the following is claimed:

1. A communication system, comprising:
a transceiver; and
a magnetic antenna structure having a substrate, a first magneto-dielectric layer, and a conductive radiator, wherein the radiator is conductively coupled to the transceiver for wirelessly radiating an electrical signal from the transceiver, wherein the first magneto-dielectric layer and the radiator are formed on the substrate, and wherein the first magneto-dielectric layer comprises magnetic material having a relative permeability greater than 1 and a relative permittivity greater than 1.

2. The system of claim 1, wherein the first magneto-dielectric layer is positioned between the substrate and the radiator.

3. The system of claim 1, wherein the radiator is positioned between the first magneto dielectric layer and the substrate.

4. The system of claim 1, wherein the magnetic antenna structure has a second magneto-dielectric layer comprising magnetic material having a relative permeability greater than 1 and a relative permittivity greater than 1, wherein the first magneto-dielectric layer is positioned between the substrate and the radiator, and wherein the radiator is positioned between the first magneto-dielectric layer and the second magneto-dielectric layer.

5. The system of claim 1, wherein the first magneto-dielectric layer comprises a hexagonal ferrite.

6. The system of claim 1, wherein the magnetic antenna structure is a single-input, single-output (SISO) antenna structure.

7. The system of claim 1, wherein the magnetic antenna structure is a multiple-input, multiple-output (MIMO) antenna structure.

8. The system of claim 1, wherein the substrate comprises a flexible printed circuit board.

9. The system of claim 1, wherein the first magneto-dielectric layer comprises a spinel ferrite.

10. The system of claim 9, wherein the spinel ferrite is selected from at least one of the group including: Ni—Zn, Mn—Zn, Ni—Zn—Cu, Ni—Mn—Co, Co, Li—Zn, and Li—Mn.

11. A communication method, comprising:
transmitting an electrical signal from a transceiver to a magnetic antenna structure having a substrate, a first magneto-dielectric layer, and a conductive radiator, wherein the first magneto-dielectric layer and the radiator are formed on the substrate, and wherein the first magneto-dielectric layer comprises magnetic material having relative permeability greater than 1 and a relative permittivity greater than 1; and
wirelessly radiating the electrical signal from the radiator.

12. The method of claim 11, wherein the first magneto-dielectric layer is positioned between the substrate and the radiator.

13. The method of claim 11, wherein the radiator is positioned between the first magneto dielectric layer and the substrate.

14. The method of claim 11, wherein the magnetic antenna structure has a second magneto-dielectric layer comprising magnetic material having a relative permeability greater than 1 and a relative permittivity greater than 1, wherein the first magneto-dielectric layer is positioned between the substrate and the radiator, and wherein the radiator is positioned between the first magneto-dielectric layer and the second magneto-dielectric layer.

15. The method of claim 11, wherein the first magneto-dielectric layer comprises a hexagonal ferrite.

16. The method of claim 11, wherein the magnetic antenna structure is a single-input, single-output (SISO) antenna structure.

17. The method of claim 11, wherein the magnetic antenna structure is a multiple-input, multiple-output (MIMO) antenna structure.

18. The method of claim 11, wherein the substrate comprises a flexible printed circuit board.

19. The method of claim 11, wherein the first magneto-dielectric layer comprises a spinel ferrite.

20. The method of claim 19, wherein the spinel ferrite is selected from at least one of the group including: Ni—Zn, Mn—Zn, Ni—Zn—Cu, Ni—Mn—Co, Co, Li—Zn, and Li—Mn.
